(19) United States
(12) Patent Application Publication
(10) Pub. No.: US 2004/0039586 A1
(43) Pub. Date: Feb. 26, 2004

(54) Method and apparatus for monitoring events concerning record subjects on behalf of third parties

(76) Inventors: Michael A. Garvey, New City, NY (US); Dharmendra Etwaru, Queens Village, NY (US)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 10/387,229

(22) Filed: Mar. 12, 2003

Related U.S. Application Data
(60) Provisional application No. 60/364,888, filed on Mar. 13, 2002.

(51) Int. Cl. G06F 17/60

(52) U.S. Cl. 705/1

(57) ABSTRACT

An event notification and risk monitoring system (10), for providing to an interested third party (15) (such as an employer) notification of events newly made part of public records of individuals, records related to the performance of tasks by the individuals, and for also providing values for metrics used in assessing risks associated with the tasks. One application is to provide event notification and risk monitoring for an employer for risks associated with drivers employed by the employer. The system (10) includes a database management and reporting system (11) and a record database (12), with the former populating the latter with information obtained from a source (14) of the public records (a source such as a state department of motor vehicles), information often in a non-standard format and so requiring that it be parsed and converted to a format suitable for business-to-business communications, a format such as XML.

### CROSS REFERENCE TO RELATED APPLICATION

Reference is made to and priority-claimed from U.S. provisional application Ser. No. 60/364,888, filed Mar. 13, 2002, and entitled “METHOD AND APPARATUS FOR MONITORING EVENTS CONCERNING RECORD SUBJECTS ON BEHALF OF THIRD PARTIES.”

### TECHNICAL FIELD

The present invention pertains to the field of computer-assisted risk management. More particularly, the present invention pertains to a risk management computer system for acquiring and reporting data related to a change in the risk an employee presents to the employee's employer because of a risk-changing event, such as the employee's having been issued a citation for having committed a moving violation in the operation of a motor vehicle.

### BACKGROUND ART

It is generally agreed that a company that has at least some employees perform duties that could possibly cause harm to the public has a duty of care to the public to monitor the employees to the extent possible and reasonable. For example, a company that owns a fleet of motor vehicles could be expected not to employ as drivers persons who have a record of moving violations, at least if such information is available to the company, i.e. e.g. if the state motor vehicle government agency makes such information available to employers. The operation of the motor vehicles poses a risk to the public and hence a risk to the company; the risk to the company is twofold: there is risk because of possible liability in case of having employed persons with poor driving records, and there is risk of lost revenues due to damage to a fleet vehicle and down-time of the damaged fleet vehicle.

Continuing to use as a specific example the case of a company that operates a fleet of motor vehicles, if a state in which the motor vehicles is-operated does provide what is sometimes called “event notification” that makes available to a company information that can be used by the employer to monitor the driving records of its employees, depending on the form in which the information is provided, for the employer to use the information may require substantial effort, so much so that in many cases companies do not make use of the available information. As a specific example, the New York State Department of Motor Vehicles operates a License Event Notification System (LENS) that provides event notification sufficient for an employee to monitor drivers it employs for a fleet of motor vehicles. A partial LENS report is shown in FIG. 1; only the portion of the report for a single driver is shown. A full LENS report, which by agreement with the subscriber is sent to a specified e-mail address, includes a listing of all drivers and then a recitation of the record for each, in turn. As is evident from FIG. 1, a LENS output is difficult to use because it requires an external legend to understand the meaning of many of the items provided in the report and many of the field values occurring in the report are of no possible meaning to the employer. (It does however include an indication of whether there has been a change in the record since the last LENS report.) Thus, a LENS report is hard to read and virtually impossible to archive and then later query so as to be able to monitor trends for individuals or for all of the fleet drivers, or to perform overall risk assessment monitoring.

Because reports of public records of employees in connection with a task that presents risk to an employer are generally not directly useful in risk monitoring because of typically providing a mere recitation of the public records, what is needed is an automated system for providing true event notification, as opposed to simply providing a recitation of a records of employees in the performance of a task that presents risk to the employee's employer and for which there is a public record. Also, it would be advantageous for a company to gauge the overall risk it faces on account of the performance of the task by its employees, and so to be able to assess the effectiveness of any policies or practices it may have implemented in an effort to reduce the risk.

### SUMMARY OF THE INVENTION

Accordingly, in a first aspect of the invention, a system is provided for use in connection with monitoring records of one or more subjects on behalf of a third party, the records of subjects being maintained by a monitoring party, the system characterized by: a database management and reporting system, for providing a request for event information for the subjects, responsive to the event information, for determining event notifications based on parsing the event information, and for providing to the interested third party the event notifications in a form predetermined to be intelligible to the interested third party according to predetermined routing instructions; and a record database, for storing the predetermined routing instructions.

In accord with the first aspect of the invention, the record database may be used by the database management and reporting system to store event information so as to allow querying the event information to provide reports of event information for different time periods.

Also in accord with the first aspect of the invention, the event information may be provided to the database management and reporting system by the monitoring party based upon an earlier request that the monitoring party provide event notifications concerning the record subjects at or near the time when the monitoring party itself receives information on events concerning the record subjects.

Also in accord with the first aspect of the invention, the predetermined routing instructions may include information relating the record subjects to the interested third party, and also include instructions as to where event information is to be communicated.

Also in accord with the first aspect of the invention, the records may be driver records maintained by a state department of motor vehicles, the monitoring party may be the state department of motor vehicles, the subjects may be employees of a company who drive vehicles as at least part of the work the employee is required to perform for the company, and the interested third party may be either the company or a related entity having in any case authorization to obtain and review the driver records of the employees.

Also in accord with the first aspect of the invention, the records may be credit reports of employees of a company and may be maintained by a credit reporting agency, the monitoring party may be the reporting agency, the subjects may be the employees, and the interested third party may be either the company or a related entity having in any case authorization to obtain and review the credit reports of the employees.

Also in accord with the first aspect of the invention, the monitoring party providing the event concerning the record subject may be an automated event notification system for automatically providing event notifications according to coded registration information, and the system may be further characterized in that it is responsive to uncoded registration information provided by the one or more associated interested third parties, the uncoded registration information being input using a form and an interface that error checks entries made to the form as the entries are being made, and in response to the uncoded registration information provides to the monitoring party coded registration information, the coded registration information being in a form specified by the monitoring party.

Still also in accord with the first aspect of the invention, after parsing the event information received from the monitoring party, the database management and reporting system may create an extensible markup language (XML) or similar document including the event information. Further, in providing event notification to the interested third party, the database management and reporting system may communicate the XML document or a corresponding other XML-type document to the interested third party. Further still, the corresponding other XML-type document may be an HTML document or a WML document. Also further, the database management and reporting system may populate the record database using the XML document. Also further still, the database management and reporting system may retrieve event information from the record database using a query, compare it with event information newly obtained from the monitoring party, prepare another XML-type document based on the comparison providing any changes to records of subjects since last obtaining event information from the monitoring party, and communicate the other XML-type document to the interested third party by way of event notification.

Even still also in accord with the first aspect of the invention, the database management and reporting system may retrieve event information from the record database and construct a value for a predetermined metric representing risk indicated by the records of the subjects. Further, the risk metric may be given by:

$$R = \{ {\sum }_{i = 1}^{n} {w}_{i} {x}_{i} \} \frac{{N}_{0}}{{N}_{drivers}}$$

in which n represents the number of different kinds of events, N₀ represents a normalizing value, N_{drivers} represents the number of subjects, the wᵢ are the weights for different kinds of events, and the xᵢ represent the number of occurrences of each kind of event during a reporting period.

Even still also in accord with the first aspect of the invention, the database management and reporting system may perform event notification according to a proactive notification protocol that refers to nodes of a reporting tree for indicating to whom to report to in an organization of the interested third party, and how to respond in case of failing to receive an acknowledgment from the interested third party.

Yet even still also in accord with the first aspect of the invention, the proactive notification protocol may also indicate how often to obtain records of subjects being maintained by the monitoring party on behalf of the interested third party.

In a second aspect of the invention, a method is provided for use in connection with monitoring records of subjects on behalf of a third party, the records of subjects being maintained by a monitoring party, the method characterized by: a step of obtaining updates to event information from the monitoring party; and a step of parsing the event information to create an XML-type document containing the event information for use in providing event notification to the third party.

In accord with the second aspect of the invention, the method may also comprise a step of communicating the event information to the third party as an XML-type of document according to a proactive notification protocol.

Also in accord with the second aspect of the invention, the method may also comprise: a step of storing the event information in a record database; and a step of querying the record database to provide reports of event information for different time periods.

Still also in accord with the second aspect of the invention, the method may also comprise: a step of calculating values for a risk metric for each of the periods of time; and a step of communicating the risk metric values to the third party as an XML-type document.

### BRIEF DESCRIPTION OF THE DRAWINGS

The above and other objects, features and advantages of the invention will become apparent from a consideration of the subsequent detailed description presented in connection with accompanying drawings, in which:

FIG. 1 is a slightly abbreviated partial output of a license event notification system (called LENS) operated by the New York State Department of Motor Vehicles, showing the driving record for a single driver of a company subscribing to the system;

FIG. 2 is a block diagram/flow diagram of a system according to the invention;

FIG. 3 is a schematic illustrating the invention of FIG. 1 from another perspective;

FIG. 4 is an example of a report provided by the invention, showing the last activity affecting the licenses of a number of drivers all employed by the same employer, and showing the manager of each driver to whom event notifications are to be provided by the invention;

FIG. 5 is another version of the report of FIG. 4;

FIG. 6 is an example of a report of all events, occurring over some predetermined time, concerning a single driver, according to the invention;

FIG. 7 is an example of a detailed event report (for a particular driver) according to the invention;

FIG. 8 is a schematic illustration of the view of data relating to risk as provided by a state department of motor vehicles and a view of the data related to risk as provided by a system according to the invention;

FIGS. 9A and 9B are respectively a tabular display illustrating the calculation of a risk metric and a corresponding graph of the risk metric over time, with the risk metric plotted alongside the number of accident prevention courses completed during each time interval;

FIG. 10 is a schematic illustration of what is called here a safety meter, a tabular (but could be graphical) display summarizing the state of risk at a moment in time for a company using a fleet of drivers;

FIG. 11 is a flowchart of the operation of a system according to the invention, such as is shown in FIG. 2;

FIG. 12A is a schematic illustration of a reporting tree for use in event notification;

FIG. 12B is a schematic illustration of a tabular form of a proactive notification protocol that refers to the reporting tree of FIG. 12A; and

FIG. 12C is a schematic illustration of a contact directory for use in automatic and manual (last resort) reporting.

### BEST MODE FOR CARRYING OUT THE INVENTION

The invention provides a way to monitor what are here called events related to record subjects on behalf of interested third parties and automatically notifying the third parties of the events at or near the time the event becomes known. The events are conclusions regarding an occurrence affecting the record subject or an action or omission made by the record subject; events can thus include invalidating events, such as e.g. the expiration of a license. The events are known to a monitoring party, and the invention obtains the information concerning the events from the monitoring party and provides the information to the interested third parties—one or more interested third parties per record subject, such interested third parties being referred to here as associated (with the record subject) interested third parties. The invention interfaces with the monitoring party on behalf of the associated interested third parties, such an interface being needed because the monitoring parties are often governmental agencies that are not adequately staffed or invested to develop an interface that is reasonably useful for interested third parties unless the interested third parties are of such a size that they employ staff having a job description that includes as a substantial component interfacing with the monitoring parties. Thus, without the invention, many smaller interested third parties operate without receiving event notifications. One example of an event notification is a notifications of a vehicle operating infraction by an employee employed as a driver by an associated interested third party. Not being aware of an event concerning the driving record of one of its professional drivers can result in the professional driver continuing in a position where others are put in danger, and so the associated interested third party is exposed to significant heightened liability for any damage caused by the driver on account of the driver having a record indicating that the driver is possibly unfit for employment as a driver.

The invention is described below in connection with monitoring driver's licenses of drivers employed by an employer. Thus, in the description below, the record subject is a driver, the interested third party is the driver's employer, and the monitoring party is a state department of motor vehicles or equivalent state government agency. It should be understood, however, that the invention comprehends providing event notifications to associated interested third parties for other than events concerned with the operation of a motor vehicle by a professional driver. For example, the invention comprehends providing to interested third parties notifications of events concerning the credit worthiness of individuals. Some specific examples include using the invention to monitor the credit rating of bonded employees of a company, such as bonded employees of an armored car money carrying service or bonded employees of a security service for guarding valuable assets of different companies, or employees who otherwise have a fiduciary duty to customers, such as employees of a stock brokerage. In such cases, if the employee were to have been imprudent in managing a personal budget, the employee might be a higher risk to the employer because the employee would be more tempted to take advantage of the position of trust the employee holds. For example, a security guard who has run up a gambling debt, and so whose credit rating has been directly or indirectly affected, might be more tempted to steal some of the assets the employee is supposed to guard. Thus, the invention would be used to obtain at regular intervals credit ratings from a credit reporting bureau on behalf of the employer of the bonded employees, who assumedly would have given the employer authority to ask for such credit ratings, and would then provide event notification to the employer as described in the case of using the invention for event notification of employees who drive a vehicle as at least part of their job. More generally, as is obvious from what has so far been described, the invention is of use in any situation in which an employer or other interested third party has the right to one or another type of information on individuals, information that is gathered by a monitoring organization which then acts as a source of monitoring records on the individuals, and the invention then provides what is in essence value-added interfacing between the interested third party and the source of records in the way of tailored event notification, risk metrics, and information parsing suitable for business-to-business communications, as mentioned or described below. The key to understanding useful applications of the invention is to look for situations in which individuals perform tasks that can impose liability on another party who has the authority to receive and monitor information about the individuals relevant to their performing the tasks, and there is a monitoring organization/source of records that can provide the information.

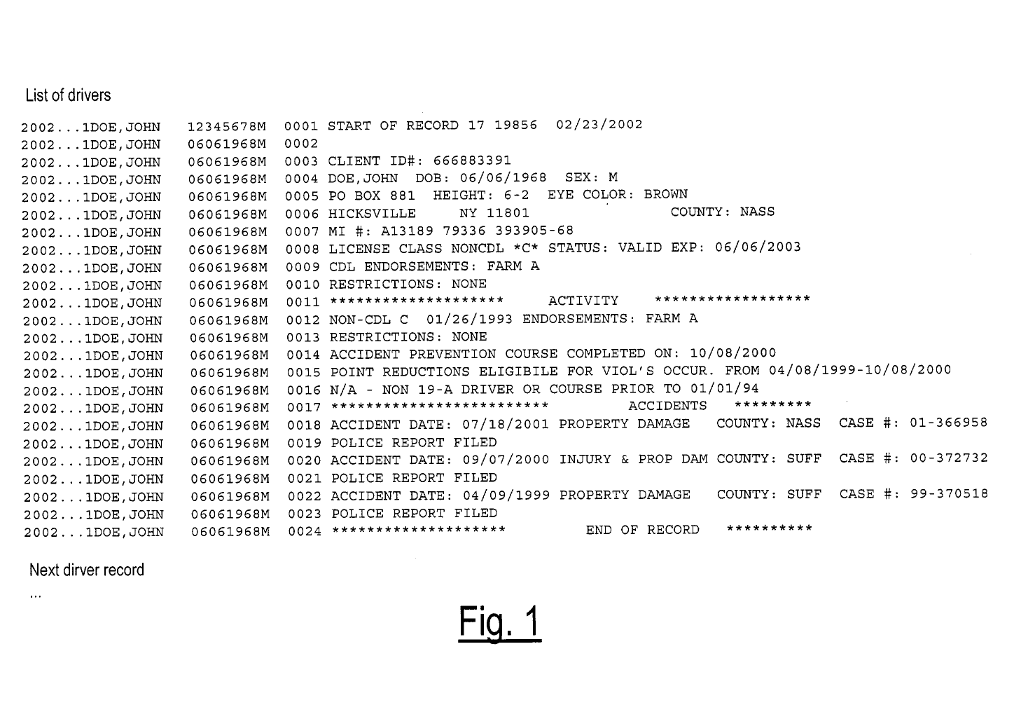

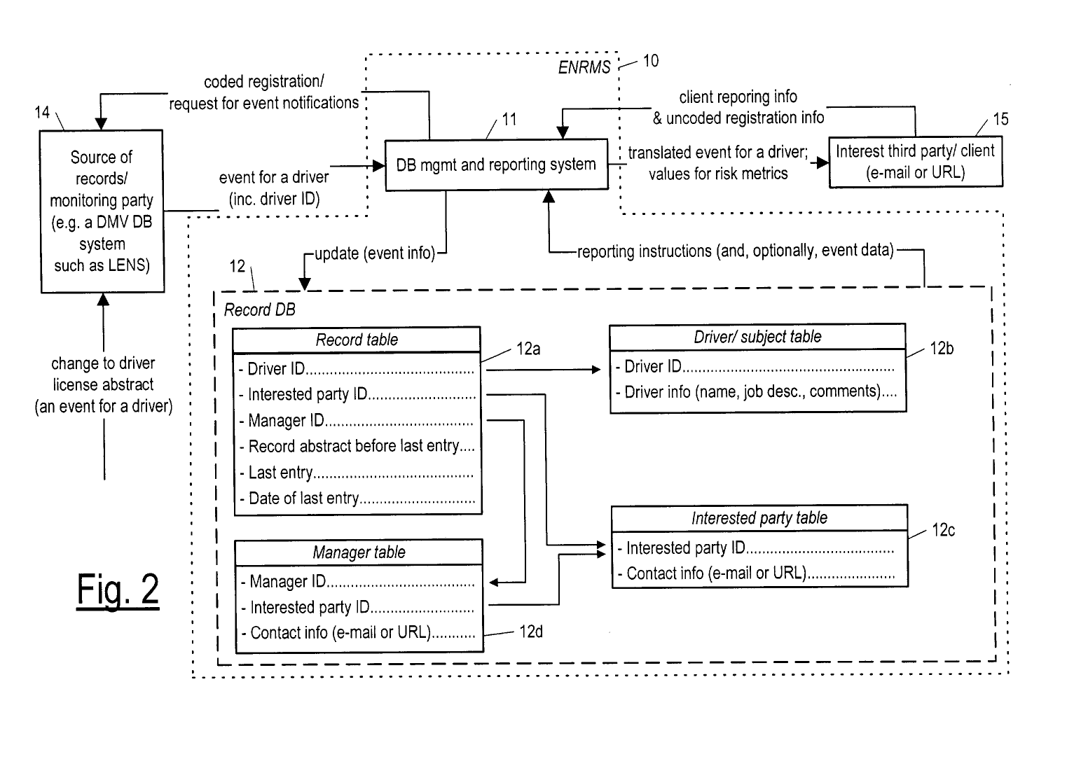

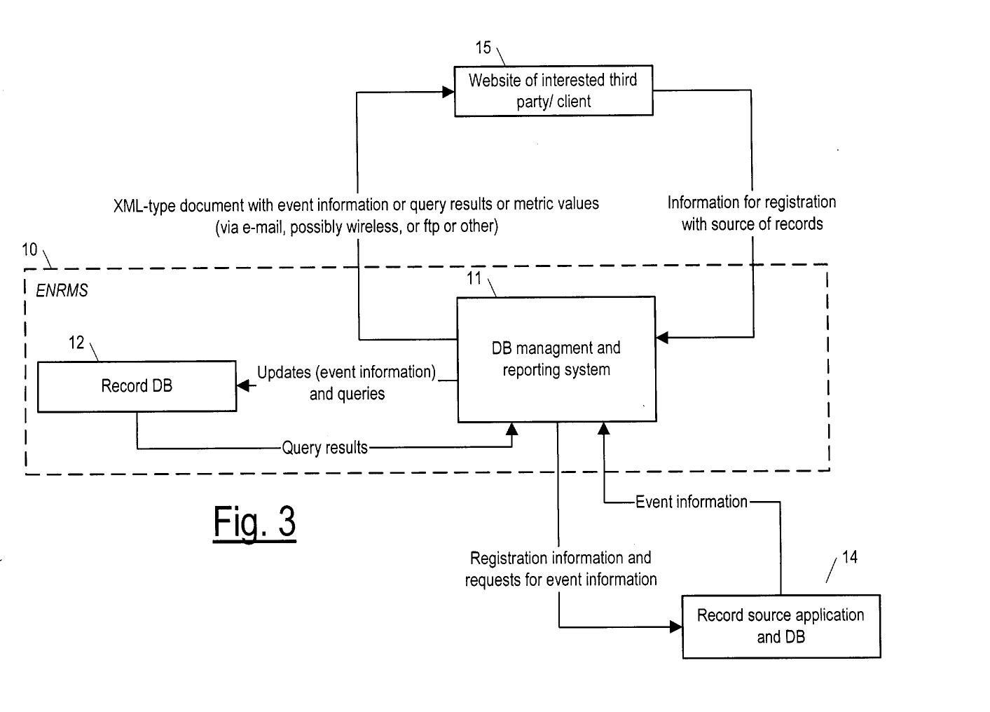

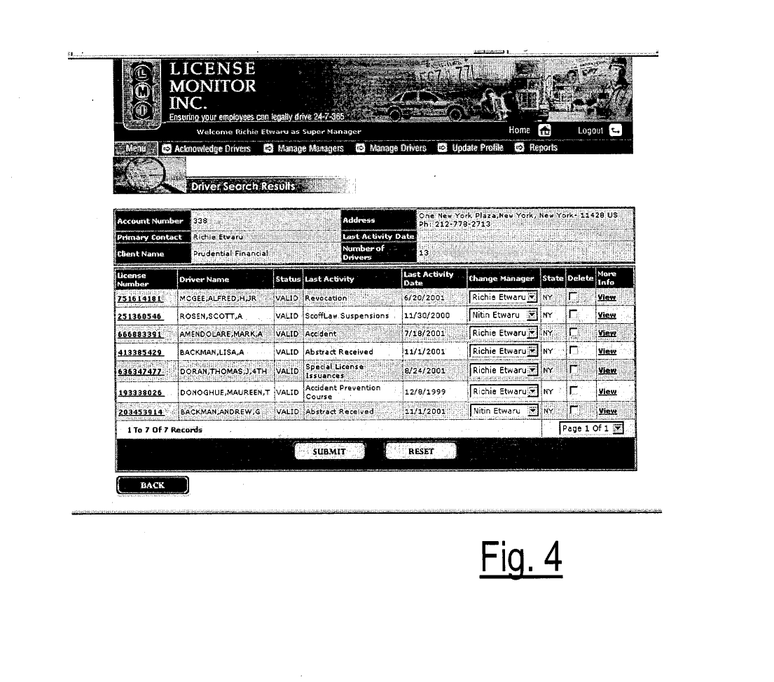

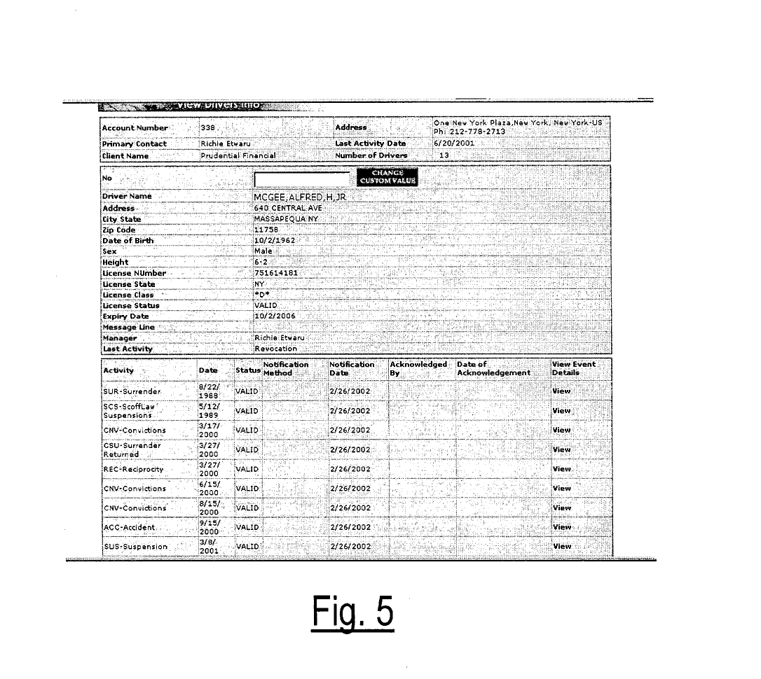

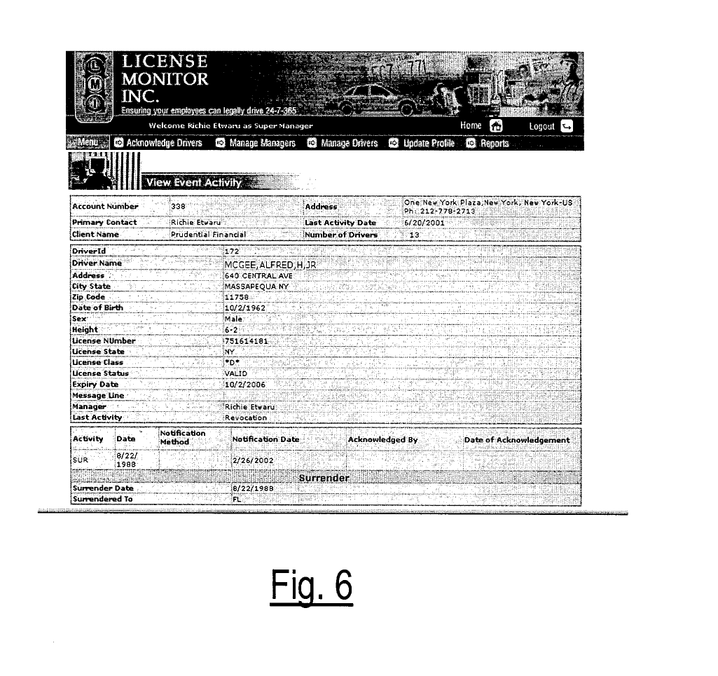

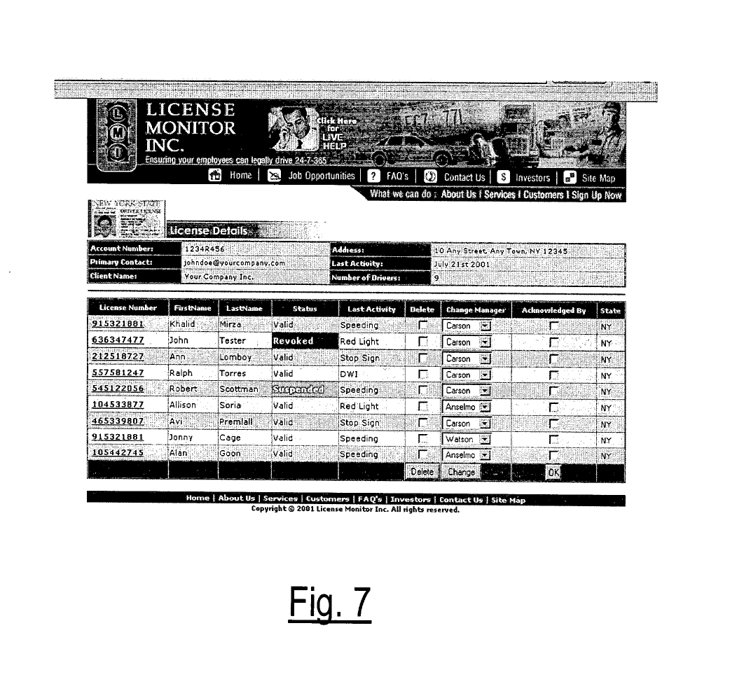

Referring now to FIGS. 1-7, the invention is shown in FIGS. 2 and 3 as an event notification and risk monitoring system (ENRMS) 10 (sometimes referred to here as LMI) including a database management and reporting system 11 and a record database 12. The ENRMS 10 translates event information from a source 14 of event information, i.e. from a monitoring party such as a state department of motor vehicles (DMV) database, into a form an interested third party/client 15 (i.e. a user of the ENRMS 10) can easily use. For example, the invention translates the output of the New York State DMV license event notification system (LENS), an example of which is given as FIG. 1, into a form such as shown in FIGS. 4 and 5. In doing so, the invention, in the preferred embodiment, saves the event information provided by the source 14 in a record database 12, thereby allowing the user to request reports tailored to the user's needs, such as a report showing all drivers (employed by the user) who have been issued a ticket for speeding over the last year, in order to be able to direct those drivers to a responsible-driver education program. In addition, the record database makes possible a view of all events for a given driver, as in FIG. 6, and a detailed view of a selected event, as in FIG. 7.

In the preferred embodiment, in order to save event information in the record database 12, the invention parses the event information from the source 14 of event information so as to determine values for predetermined fields (the fields of the records of the record database 12), and produces from the parsed event information a document according to so-called XML (extensible markup language), which is a standard governed by the World Wide Web consortium, which operates a website at w3c.org. Version 1.0 of XML is able to be used in practicing the invention, as are later versions. Once the parsed event information is in XML form, it is written to the record database 12, preferably an SQL (standard query language) Server 2000, available from Microsoft Corporation. Once in the record database, the event information can be viewed using different queries (filters), including queries that provide values for predetermined metrics indicating an overall level of risk, or a level of risk attributable to individual drivers as a result of trends in the driver's performance according to the event information obtained over time from the source 14 of event information. The results of the queries, if not already in the form of an XML document, are preferably first transformed into XML form and then possibly transformed into one or another other form, as appropriate to the client, especially other XML-type forms such as HTML (hypertext transport markup language) for display by an Internet browser (such as a Netscape browser or an Opera browser) or WML (wireless markup language) for display by a cell phone (having an LED or other type of display screen). The results of the queries are however maintained in XML form if the results are for capture by other applications, including applications used by the interested third party/client 15; thus, in case of (used in e.g. business-to-business communications).

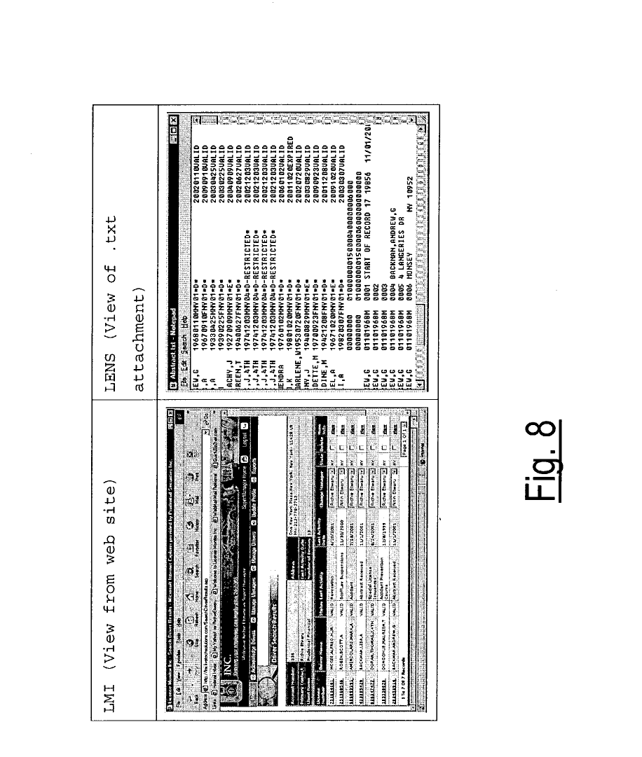

It is important to understand that as a result of the invention, the client (user) receives event information in an easily understood, self-explaining format, i.e. according to a form, such as the forms of FIGS. 3-6, in which each field value is shown with a corresponding field name so that the field value can be understood without reference to an external legend, as opposed to the format of the LENS output (see attachment B), in which field values are given with no corresponding field names. FIG. 8 offers a side-by-side comparison of the views of the information provided by LENS compared to that provided by the invention. In addition, in the case of any source of event information that provides event notification whenever an event occurs, as opposed to at regularly scheduled intervals no matter when the events occur, the ENRMS 10 provides a client with a dynamic snapshot of the driving records of its drivers. LENS of the New York State DMV is one source 14 of event information that does provide event notifications when events occur (as opposed to when asked or at regularly scheduled times), and as indicated in FIG. 2, in order to receive such event notifications, the client 15 provides the ENRMS 10 according to the invention with client reporting information and uncoded registration information, and the ENRMS 10 populates its record database 12 with that information and also registers with the LENS 14 on behalf of the client, by deriving from the uncoded information provided by the client, the precisely coded information required by LENS.

The invention is also of use in case of sources 14 of event information that do not provide automated event notification. For example, a state DMV may not operate a LENS type system, but will still maintain a record of events for each licensed driver. The ENRMS 10 in such a case would periodically query the source 14 for the records of all drivers of an employer, compare the official records with the records the ENRMS 10 maintains in its record database 12, derive from the comparison what events have transpired since the last query, and provide event notifications to the employer accordingly.

The record database 12 is, in the preferred embodiment, a relational database, and includes at least a record table 12a having as fields a driver identifier, an interested party identifier (the employer of the driver, i.e. the client or user of the invention), and a record abstract for the driver. The driver identifier relates the record table 12a to driver/subject table 12b, where more information is stored about the driver that is therefore not necessary to repeat in each record of the record table 12a. The interested party identifier field of the record table 12a relates the record table 12a to an interested party table 12c, which includes other information about the interested party. In the preferred embodiment, the record table 12a also includes a manager identifier for each driver; the manager identifier relates the record table 12a to a manager table 12d, which includes information on how event information for all drivers managed by a manager is to be reported to the manager.

As mentioned, the invention allows the calculation of values for risk metrics, and so in case of the use of the invention to provided event notification and risk monitoring of fleet drivers of an employer, the risk to the employer posed by the performance of the fleet drivers in the aggregate, and the risk attributable to individual employees.

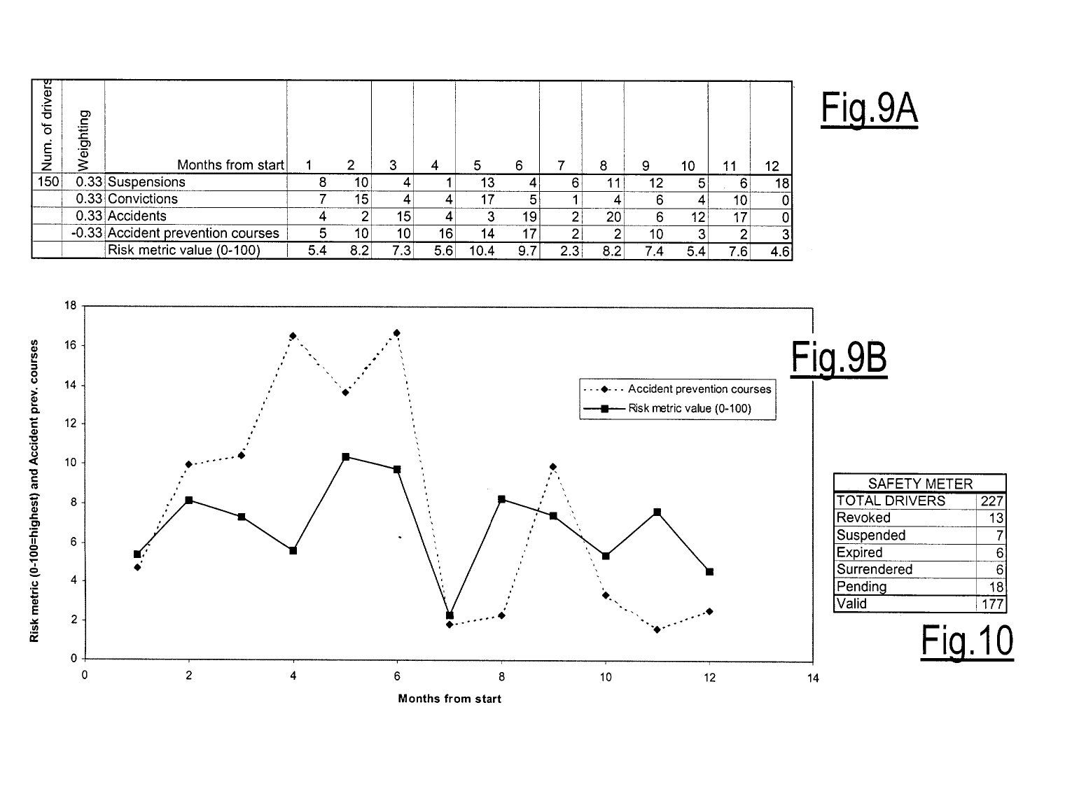

Referring now to FIGS. 9A and 9B, an overall risk metric calculation according to the invention is illustrated, a calculation in which a value for the overall risk metric is assigned so as to have a maximum value of 100 in case of all drivers each having had one suspension, one accident, and one conviction in a one-month period, and none having completed an accident prevention course during the period. The formula used for the risk metric is:

$$R = \{ {\sum }_{i = 1}^{4} {w}_{i} {x}_{i} \} \frac{{N}_{0}}{{N}_{drivers}} \qquad ( 1 )$$

in which N₀ is a normalizing value, N_{drivers} is the number of drivers in the fleet, the Wᵢ are the weights shown in FIG. 9A (with the weighting for accident prevention courses being negative so as to reduce the value of the risk metric), the xᵢ are the number of suspensions (for i=1), convictions (for i=2), accidents (for i=3), and completed accident prevention courses (for i=4) in the indicated month. Although the weighting for the different events used by the metric is in some respects arbitrary, the metric is nevertheless useful in that a user can, over time, internalize a correlation between the risk metric values and more absolute, real-world related overall and individual risk vales.

A software system according to the invention would typically not only provide metric values as described above, but also what are here called safety meters, such as shown in FIG. 10. Besides a tabular display format for a safety meter, a graphical display, such as a pie chart is sometimes advantageously used.

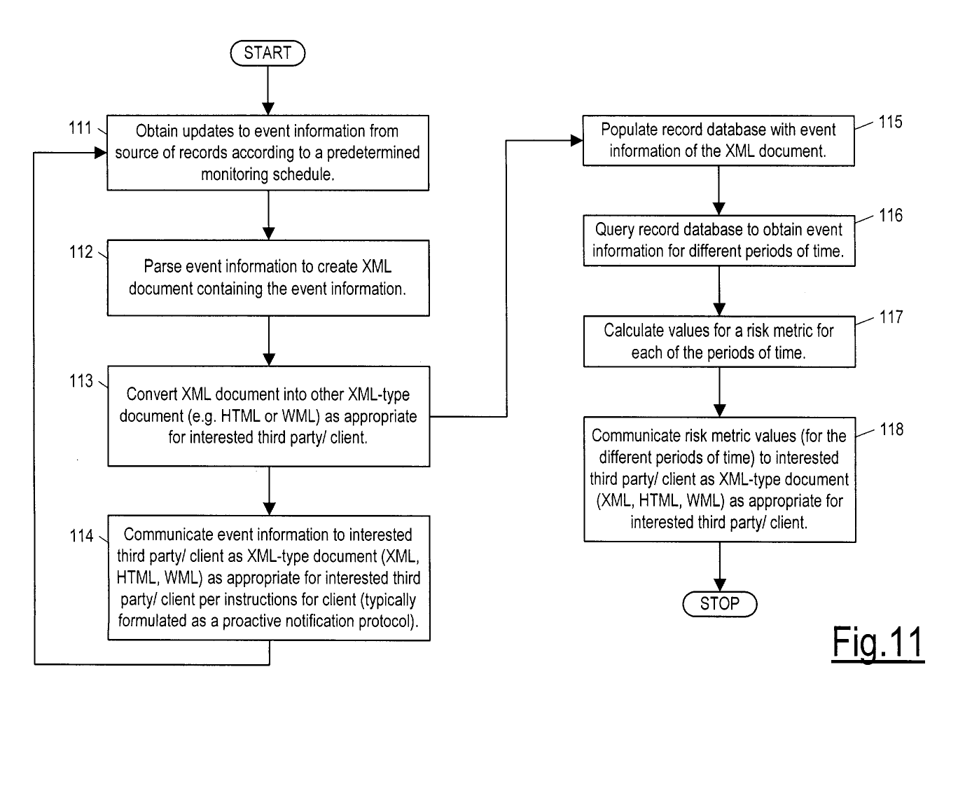

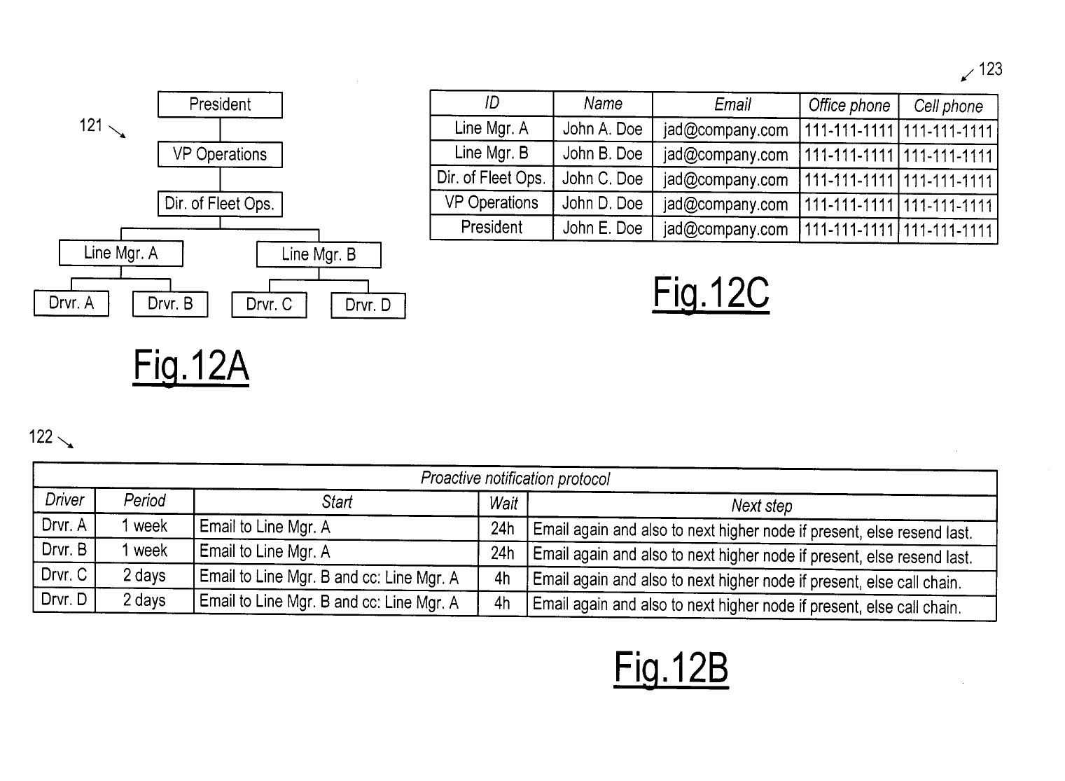

Referring now to FIG. 11, a typical scenario of the use of the invention (and so a method of event notification according to the invention) is shown as beginning (after the ENRMS 10 registers with the source 14 of driver records) with a step 111 in which the ENRMS obtains updates to event information from the source 14 of records according to a predetermined (although variable) monitoring schedule. In a next step 112, the ENRMS parses event information to create an XML document containing the event information. In a next step 113, the ENRMS converts the XML document into one or another other type of XML-type document (e.g. HTML or WML), as appropriate for the interested third party/client according to information previously obtained from the interested third party. In a next step 114, the ENRMS communicates the event information to the interested third party/client as one or another kind of XML-type document (XML, HTML, WML), as appropriate for the interested third party/client, and according to a proactive notification protocol based on direction from the interested third party and previously obtained from the interested third party. (A proactive notification protocol is described below in connection with FIGS. 12A-C.) In a next step 115, the ENRMS populates the record database 12 with the event information of the XML document. In a next step 116, the ENRMS queries the record database 12 to obtain event information for different periods of time. In a next step 117, the ENRMS calculates values for a risk metric for each of the periods of time. Finally, in a next step 118, the ENRMS communicates the risk metric values (for the different periods of time) to the interested third party/client as an XML-type document (XML, HTML, WML) as appropriate for the interested third party/client.

Referring now to FIGS. 12A-C, according to a preferred embodiment of the invention, the interested third party provides information and instructions to the ENRMS 10 for use in event notification and risk monitoring on behalf of the interested third party, information and instructions that are structured as what is here called a proactive notification protocol (PNP) 122, such as is illustrated in FIG. 12B and which refers to nodes of a reporting tree 121 shown in FIG. 12A. A PNP encodes for the ENRMS how often to obtain records from the monitoring party 14, whom to report to first, in case of an event, and in case of no acknowledgment and a specified period of time, whom to report to next, and so on, and by what means reporting is to be done. A PNP is especially useful in case the interested third party is a complex organization, possibly involving even different business entities. The PNP 122 of FIG. 12B is for a hypothetical situation in which the drivers (driver C and driver D) managed by line manager B operate vehicles that pose a greater risk to the interested third party than do the drivers (driver A and driver B) managed by line manager A; the interested third party in this hypothetical case is a single company having line managers A and B, a director of fleet operations, a vice president of operations, and a president. In case of an event relating to either Driver A or Driver B, the PNP 122 instructs ENRMS to wait twenty-four hours after sending an email to line manager A, and if no acknowledgment is received within the twenty-four hours, to then resend to line manager A but also to send to the next higher node (which in case of the first failure to acknowledge would be the Dir. of Fleet Operations). Once the top of the reporting tree 121 is reached, if there is still no acknowledgment, the PNP 122 indicates that the event notifications are simply resent (as per the last failed notification). In case of an event relating to either Driver C or Driver D, the PNP 122 instructs ENRMS to wait only four hours after sending an email to line manager B and a cc: to line manager A, and if no acknowledgment is received within the four hours, to then resend to line manager B (with a cc to line manager A) but also to send to the next higher node (of both starting nodes, but since the next higher node is the same for both line manager A and line manager B, there is only one next higher node). As a last resort, a previously provided call chain (not shown) is used to notification the interested third party. As shown in FIG. 12C, a contact directory 123 is typically constructed to enable both the automatic reporting by ENRMS and the manual reporting (by telephone) as a sometimes last resort. It should be understood that the PNP 122 of FIG. 12B is not typically in the form that would be used for automatic reporting by ENRMS; a PNP for automatic reporting, i.e. reporting by ENRMS, would be more encoded for automatic interpretation by ENRMS. The PNP of FIG. 12B is thus to be considered only illustrative of the idea of a PNP or else a preliminary form of a PNP, before encoding for use by ENRMS.

Thus, in case of using the invention to monitor the driving records of fleet drivers of an employer, the invention provides a system that can be used to continually monitor the licenses of the drivers by periodically (suitably often enough) obtaining from the state department of motor vehicles the driving records of the fleet drivers, comparing the records with the last obtained set of records, and reporting any changes. The invention thus provides near instant notification of all activity and events that appear on the driving records of the fleet drivers. In a typical application, the employer creates a master list of all driver license numbers the employer wants to monitor; the master list is provided to the state department of motor vehicles, and an arrangement is provided by which the driving records are made available in electronic form. The invention then parses the records as described above and provides any event notifications (changes) based on comparing the records with the previously obtained records; it also allows the employer to create reports providing different views of the risk faced by the employer and calculates for the employer a numerical assessment of the risk according to a predetermined metric. In a usual such application, the invention reports license suspensions, revocations, expirations, court convictions, license restorations, accidents, and accident prevention course completions. The invention thus allows an employer to take action to mitigate risk as seems prudent. Using the invention in combination with a policy of taking risk mitigation action can be said to amount to a so-called risk control program, and some insurance carriers offer discounts for such programs. Industries and organizations that could benefit from a fleet-driver application of the invention include trucking companies, busing companies, airline companies, taxi companies, limousine, delivery service companies, and charter transportation companies (air, ground, and marine), whether the company is for-profit or not-for-profit private sector or governmental.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. A system (10) for use in connection with monitoring records of one or more subjects on behalf of a third party (15), the records of subjects being maintained by a monitoring party (14), the system characterized by:
a database management and reporting system (11), for providing a request for event information for the subjects, responsive to the event information, for determining event notifications based on parsing the event information, and for providing to the interested third party (15) the event notifications in a form predetermined to be intelligible to the interested third party according to predetermined routing instructions; and
a record database (12), for storing the predetermined routing instructions.

2. The system of claim 1, wherein the record database (12) is used by the database management and reporting system (11) to store event information so as to allow querying the event information to provide reports of event information for different time periods.

3. The system of claim 1, wherein event information is provided to the database management and reporting system (11) by the monitoring party (14) based upon an earlier request that the monitoring party (14) provide event notifications concerning the record subjects at or near the time when the monitoring party itself receives information on events concerning the record subjects.

4. The system of claim 1, wherein the predetermined routing instructions include information relating the record subjects to the interested third party, and also include instructions as to where event information is to be communicated.

5. The system of claim 1, wherein the records are driver records maintained by a state department of motor vehicles, the monitoring party (14) is the state department of motor vehicles, the subjects are employees of a company who drive vehicles as at least part of the work the employee is required to perform for the company, and the interested third party (15) is either the company or a related entity having in any case authorization to obtain and review the driver records of the employees.

6. The system of claim 1, wherein the records are credit reports of employees of a company and are maintained by a credit reporting agency, the monitoring party (14) is the reporting agency, the subjects are the employees, and the interested third party (15) is either the company or a related entity having in any case authorization to obtain and review the credit reports of the employees.

7. The system as in claim 1, further characterized in that the monitoring party (14) providing the event concerning the record subject is an automated event notification system for automatically providing event notifications according to coded registration information, and the system is further characterized in that it is responsive to uncoded registration information provided by the one or more associated interested third parties, the uncoded registration information being input using a form and an interface that error checks entries made to the form as the entries are being made, and in response to the uncoded registration information provides to the monitoring party (14) coded registration information, the coded registration information being in a form specified by the monitoring party (14).

8. The system as in claim 1, wherein after parsing the event information received from the monitoring party (14), the database management and reporting system (11) creates an extensible markup language (XML) document including the event information.

9. The system as in claim 8, wherein, in providing event notification to the interested third party (15), the database management and reporting system (11) communicates the XML document or a corresponding other XML-type document to the interested third party (15).

10. The system as in claim 9, wherein the corresponding other XML-type document is an HTML document or a WML document.

11. The system as in claim 8, wherein the database management and reporting system (11) populates the record database (12) using the XML document.

12. The system as in claim 11, wherein the database management and reporting system (11) retrieves event information from the record database (12) using a query, compares it with event information newly obtained from the monitoring party (14), prepares another XML-type document based on the comparison providing any changes to records of subjects since last obtaining event information from the monitoring party (14), and communicates the other XML-type document to the interested third party (15) by way of event notification.

13. The system as in claim 1, wherein the database management and reporting system (11) retrieves event information from the record database (12) and constructs a value for a predetermined metric representing risk indicated by the records of the subjects.

14. The system as in claim 13, wherein the risk metric is given by:
$$R = \{ {\sum }_{i = 1}^{n} {w}_{i} {x}_{i} \} \frac{{N}_{0}}{{N}_{drivers}}$$
in which n represents the number of different kinds of events, N₀ represents a normalizing value, N_{drivers} represents the number of subjects, the wᵢ are the weights for different kinds of events, and the xᵢ represent the number of occurrences of each kind of event during a reporting period.

15. The system as in claim 1, wherein the database management and reporting system (11) performs event notification according to a proactive notification protocol (122) that refers to nodes of a reporting tree (121) for indicating to whom to report to in an organization of the interested third party (15), and how to respond in case of failing to receive an acknowledgment from the interested third party (15).

16. The system as in claim 1, wherein the proactive notification protocol (122) also indicates how often to obtain records of subjects being maintained by the monitoring party (14) on behalf of the interested third party (15).

17. A method for use in connection with monitoring records of subjects on behalf of a third party (15), the records of subjects being maintained by a monitoring party (14), the method characterized by:
a step (111) of obtaining updates to event information from the monitoring party (14); and
a step (112) of parsing the event information to create an XML-type document containing the event information for use in providing event notification to the third party (15).

18. The method of claim 17, further characterized by:
a step (114) of communicating the event information to the third party as an XML-type of document according to a proactive notification protocol (122).

19. The method of claim 17, further characterized by:
a step (115) of storing the event information in a record database (12); and
a step (116) of querying the record database (12) to provide reports of event information for different time periods.

20. The method of claim 17, further characterized by:
a step (117) of calculating values for a risk metric for each of the periods of time; and
a step (118) of communicating the risk metric values to the third party (15) as an XML-type document.
